(19) United States
(12) Patent Application Publication
(10) Pub. No.: US 2005/0021418 A1
(43) Pub. Date: Jan. 27, 2005

(54) Remote activation of digital media

(76) Inventors: Matt Marcus, New York, NY (US); Henry Poydar, Brooklyn, NY (US)

Correspondence Address: FISH & RICHARDSON P.C., CITIGROUP CENTER 52ND FLOOR, 153 EAST 53RD STREET, NEW YORK, NY, 10022-4611, US

(21) Appl. No.: 10/804,248

(22) Filed: Mar. 18, 2004

Related U.S. Application Data
(60) Provisional application No. 60/455,711, filed on Mar. 18, 2003.

(51) Int. Cl. G06F 17/60; G06F 15/16

(52) U.S. Cl. 705/26; 709/217

(57) ABSTRACT

Systems and techniques are described enable the remote activation of digital media from a personal device over a network. The techniques include one or more users browsing a repository of media files using a wired or wireless device and selecting media files from the repository for inclusion in a public queue. Every user may view the public queue on his own wireless device and add value to a media file in the queue. The file with the most associated value plays next over a playback device.

### CROSS-REFERENCE TO RELATED APPLICATIONS

This application claims the benefit of priority from U.S. Provisional Patent Application entitled “Techniques for Remote Activation Of Digital Media,” filed Mar. 18, 2003, Ser. No. 60/455,711, which is incorporated herein by reference in its entirety.

### BACKGROUND

People in various social settings may desire to alter the atmospherics of the public space they are in with a personal choice of music or other entertainment. For example, at a bar, restaurant, dance hall, billiard parlor or other public or private social venue the people in the venue may want to have music playing. It is common in such settings for there to be available a jukebox or other media playing device that can provide an opportunity for people to make personal selections, for a fee, of desired music to be played in the venue. The music selected is placed in a queue by the device and subsequently played in sequence for all people in the venue to hear.

Hence, the particular people who pay the fee choose the music that will be played in the venue. Other people in the venue also may want to hear one or more selections of the same music played. However, they may not know that the same selection is already sequenced in the queue to be played by the device. They may pay the fee and add the same selection to the queue a second time. Popular songs that many people in the venue enjoy may be heard more often than less popular songs.

The order in which the music selections are arranged in the queue may be the order in the selections were made. Thus, while more popular songs may be heard more often than less popular songs, a less popular song may be heard in the venue before a more popular song because it was sequenced in the queue before the more popular song.

Digital media may be used to store the various types of information including entertainment sources such as music or videos. The digital media may be available at the venue. Selections for playing of the digital media may be made through a wired device such as a jukebox, a wireless device such as a personal digital assistant or some other media vending device.

### SUMMARY OF THE DISCLOSURE

The systems and techniques disclosed enable activation of digital media.

Details of one or more implementations are set forth in the accompanying drawings and the description below. Other features and advantages may be apparent from the description and drawings, and from the claims.

### BRIEF DESCRIPTION OF THE DRAWINGS

These and other aspects will now be described in detail with reference to the following drawings.

FIG. 1 is a flow diagram illustrating the phases of activating media in a public space.

FIG. 2 is an implementation of a system for practicing the disclosure.

FIGS. 3-6 are interface displays of an implementation of a remote activation of digital media system.

FIGS. 7A-7C are an implementation of displays for a personal wireless device used in the disclosed system.

FIG. 8 is a public use device that may be used in the disclosed system.

Like reference symbols in the various drawings indicate like elements.

### DETAILED DESCRIPTION

The systems and techniques described enable the remote activation of digital media from a personal device over a wired or wireless network.

The remote activation system operates as a wireless jukebox. Wireless devices including laptop computers, mobile phones, and personal digital assistants may view the jukebox content over a wireless local area network (WLAN) from any location within a local area environment. Users can browse the local collection of music in the jukebox and select music tracks for playback. The system enables simultaneous interactions allowing multiple users to browse jukebox content and outbid each other for the next track to play in the environment. The track that earns the most digital tokens, or currency, plays next creating a collaborative music space where the music taste of the local users determines which musical selections are played and in what order.

The system provides for activation of the media in sequence from a media gaming queue. The users of the system can add entries to the queue and alter the order of the entries in the queue. In an implementation, the queue contains selections (or references to selections) of digital media containing music that may be played for users to hear. Some or all users in the space may use wired or wireless devices to choose one or more musical selections to be placed in the queue. The order of entries in the queue can be visible to other users with the selections closest to the head of the queue played before selections closer to the end of the queue. That is, users can know the sequence in which the music will be played by the system. The users of the system may alter the sequence of the entries in the queue by voting to move a selection closer to the head of the queue. One method of voting includes adding a currency value to that associated with a selection in the queue. In an implementation, the selection in the queue associated with more value plays before a selection associated with less value. Other interactive methods of sequencing the selections in the queue may be used.

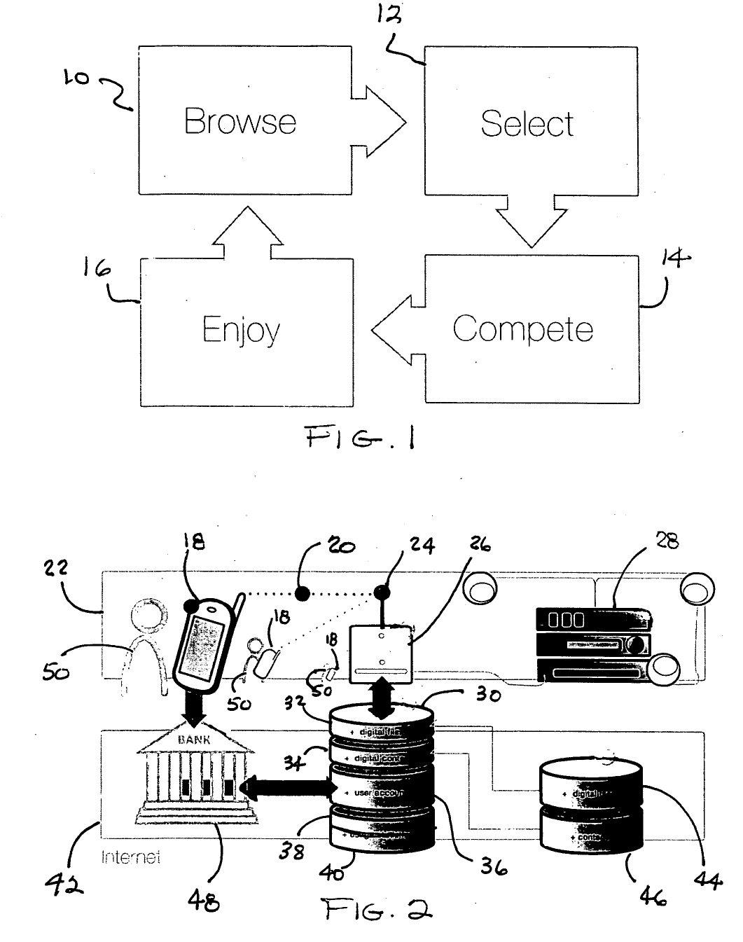

FIG. 1 is a flow diagram that depicts four phases of a remote media activation system. Users in a public space can browse 10 a catalog of digital media content on their personal wireless device, including mobile phones, personal digital assistants, laptop computers, other devices or hybrid units. Users can select 12 a media file from the catalog and add it to a public queue. Media files may be played in the sequence listed in the public queue. Every user in the public space may view the public queue on their device and alter the sequence of the media files in the queue and, thus, alter the playing sequence of the media files. The users in the space compete 14 to alter the sequence of the media files in the queue by adding points to individual files. The file with the most points at a given moment in time will be sequenced to play next over a public playback device for the users of that space to enjoy 16.

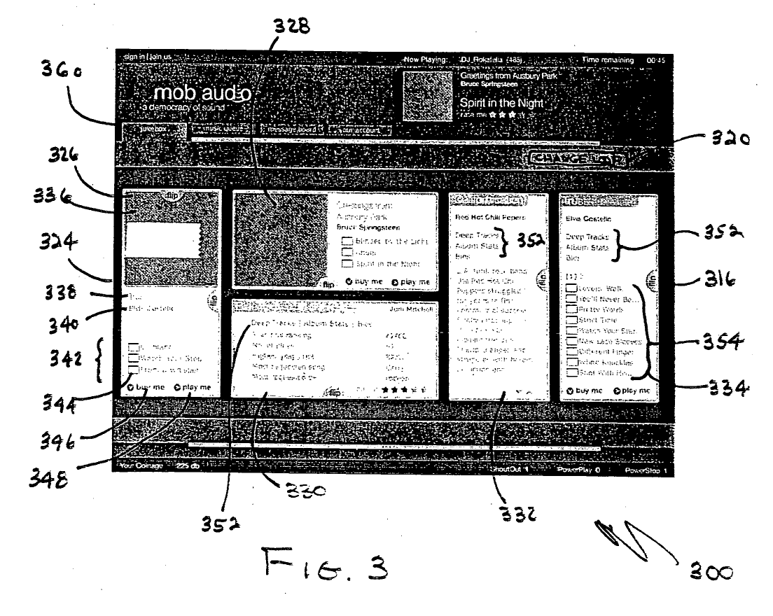

FIG. 2 illustrates an implementation of a system for remote activation of digital media. A user's 50 personal wireless device 18 or a public device (not shown) may be connected to a wireless network 20 made available by a wireless network controller 24. The network controller 24 may be connected physically or wirelessly to a local media repository device and application server 26. The local repository device 26 can drive a playback system 28 that is capable of playing digital media sequenced from a queue of user-selected digital media files from the repository and may include audio speakers and video monitors/plasma screens.

The local media repository device and application server 26 may be connected to a network server 30 that can provide access to a network including the Internet 42. The server 30 can provide to the local repository and application server 26 digital media files 32, digital content updates 34, user account information 36, digital media file retailing 38 and user system usage statistics 40. The digital media files 32 and content 34 may be received from network-connected repositories 44 and 46, respectively. The digital media files may include audio and/or video information including songs, music videos, movies and other files capable of digital formatting. The content 34 can include information related to the media files including text and/or graphics associated or related to a particular digital media file. The content also may include advertisements, promotional or historical information and related digital media files. The user's wireless device 18 or public device may be connected to the user's media activation account 48 through the network. The user may add value to the account through any known mechanism including, for example, credit card charging, bank transfer or cash payment.

The user may browse and select a digital media file from the local repository to be added to the digital media queue for playback in the space. The user also may add value from their activation account 48 to a previously selected digital media file in the queue. Upon receiving a user request for media selection or addition of value, the local repository device and server 26 may query the user's account information 36 for authorization to honor the request. Upon approval, the user account value may be updated by the server 30 over the network connection 42 to the user's media activation account 48. The server 30 also may store statistics on the user's usage of the system. A user's usage of the system may be used, for example, to add or decrease the value of the user's media activation account 48 or provide the user with targeted promotional advertisements.

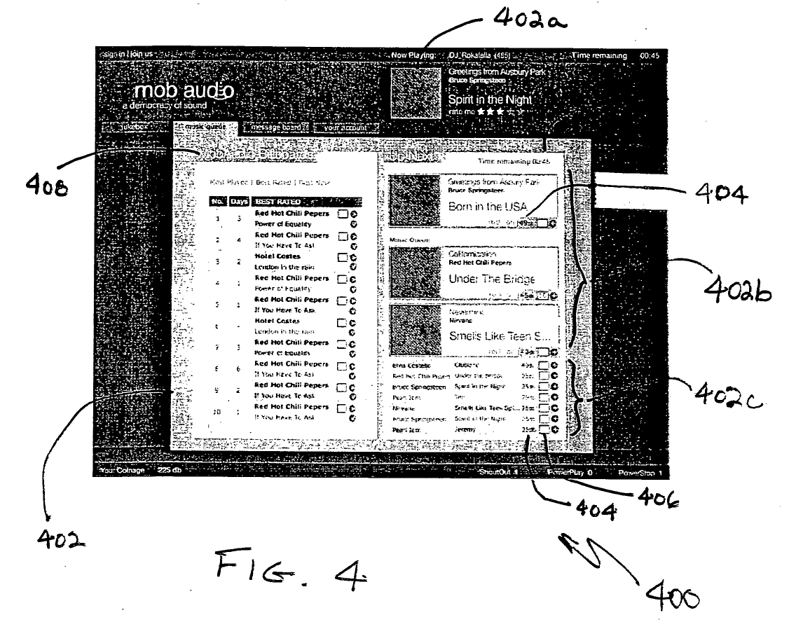

FIG. 3 illustrates an implementation of the digital media activation system using a client/server interface display 300 for a wireless jukebox and music vending machine. The interface may be used on wirelessly enabled devices, including laptop computers, person digital assistants and cellular phones. The interface may be designed, for example, in Flash format and present a smooth animated experience. In the illustrated implementation, the display provides tabs 360 for a user to select various views of the media activation system and includes “jukebox”, “music queue”, “message board” and “your account” tabs. Selection of the “jukebox” tab is illustrated in FIG. 3. The jukebox display may be made up of multiple audio loops each containing one or more music albums. The albums can be grouped according to a categorization scheme including musical genre or alphabetical range and displayed in theme panels 324. In an implementation, the audio loops spin smoothly three hundred and sixty degrees to reveal the available albums. Each album may be represented on an album card. In the implementation of FIG. 3, five album cards 326-334 are displayed. A particular card may be selected by pushing a cursor into a trigger zone (not shown) on the album card. Album loops can be changed by choosing a new loop from a change loop drop down menu 320.

The album cards 326-334 may have a front side and a back side that may be alternately displayed by selection of a flip button 316, for example, on the card. In the implementation illustrated, the front sides of album cards 326 and 328 are shown. The front side of the album card may display album cover art 336, the album title 338, the artist name 340 and one or more album tracks 342. Each track can have an associated free text box 344. A user may select a desired track by entering in the box 344 a currency value. The currency value can reflect a monetary value, a point value or other valuation scheme. A play-me button 348 may be selected to add selected songs to a public queue of tracks for playback. Similarly, other users of the system may add their own selections to the public queue. The display may provide a buy-me button 346 that triggers a purchase process of any selected song or the full album.

The flip button 316 may be selected to reveal the back side of an album card, which may include additional album information. In the implementation illustrated, the back sides of album cards 330-334 are shown. The back side can contain links 352 such as deep tracks, album statistics, and biographies. An implementation of selecting the deep tracks link is illustrated on album card 334 and presents the remaining tracks that are not shown on the front side but that are available on the album. Each deep track 354 can have a free text box associated it. A user may select a particular track for addition to the public queue by entering a value as described above. A deep track also can have a play me button, and a buy me button as was previously described.

Album card 330 illustrates an implementation of a display resulting from selection of the album stats link. The “album stats” link can present a set of statistics on the usage of the particular album on the jukebox. The usage statistics may indicate the number of times the selection has been played, the most requested track on the album, the ranking of the album from all albums in the jukebox, or other statistics. The “album stats” link also may provide for users to rate the album and may display a cumulative ranking.

Album card 332 illustrates an implementation of a display resulting from selection of the “bios” link. The “bios” link may display a biography of the band or artist and related information.

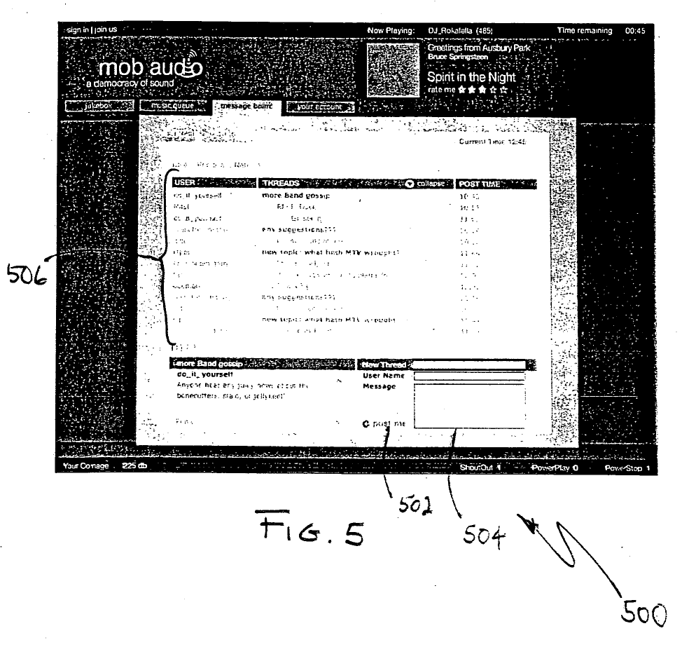

FIG. 4 illustrates an implementation of a display of a music queue interface 400. The display can present a user with a view of the public queue 402a, 402b, 402c. The music selections in the queue may be displayed in the order that the selections are sequenced to be played in the venue. The queue may be ordered in descending order of the respective associated currency value. The currently playing selection 402a can be displayed along with associated information including title, artist's name, ranking of the selection and name of the user who submitted the selection to the queue. The selections with higher currency values 402b may be displayed in a larger format than selections with lesser currency values 402c. The larger format can include more information about the selection including the artist's name, the track, album art and the name of the user who submitted the track to the queue in the queue can have displayed. The currency value 404 associated with each selection. Each selection in the queue also may have an associated free text box 406 in which users can add currency value to the respective selection. The added value can result in a new currency value associated with the respective selection. Based upon the new currency value, the corresponding selection may be promoted in sequence and, result in a re-sequencing of the selections in the public queue. All users of the system can view the re-sequenced queue. Thus, users of the system may compete to advance particular selections in the queue.

In an implementation, the music queue page also may contain billboards 408. The billboards 408 can display the albums played most often, tracks played most often and new tracks on this specific jukebox played most often. The tracks displayed on the billboard also can have a free text box used to add currency value to the respective track, play-me button to add the track to the public queue and a buy-me button to trigger a purchase process for the selected track or album.

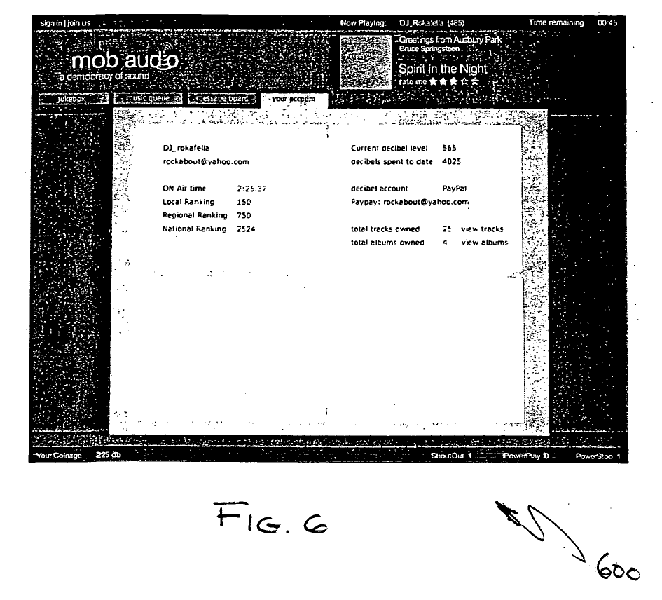

FIG. 5 illustrates an implementation of a display that includes a message board 500. A user can be presented with a message space 504 where he can enter messages in the venue and communicate with other users in that venue. When the message is posted 502, the message may be visible to other users in the venue along with previous messages posted by other users 506.

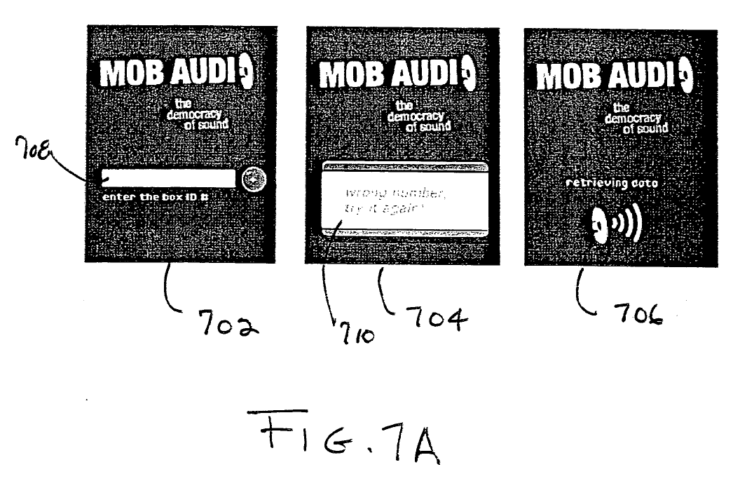

FIG. 6 illustrates an implementation of a display of an account section 600. The account section may show a user his stored-value account and give the user access to his username, password and other account-related features.

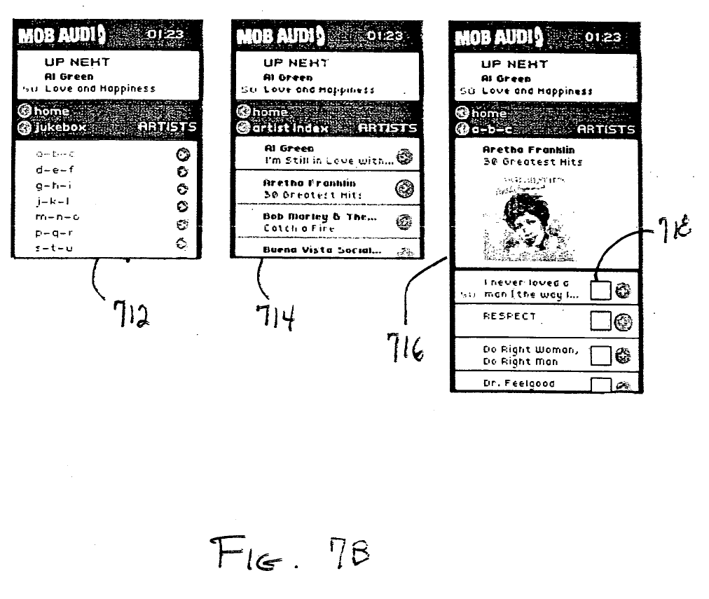

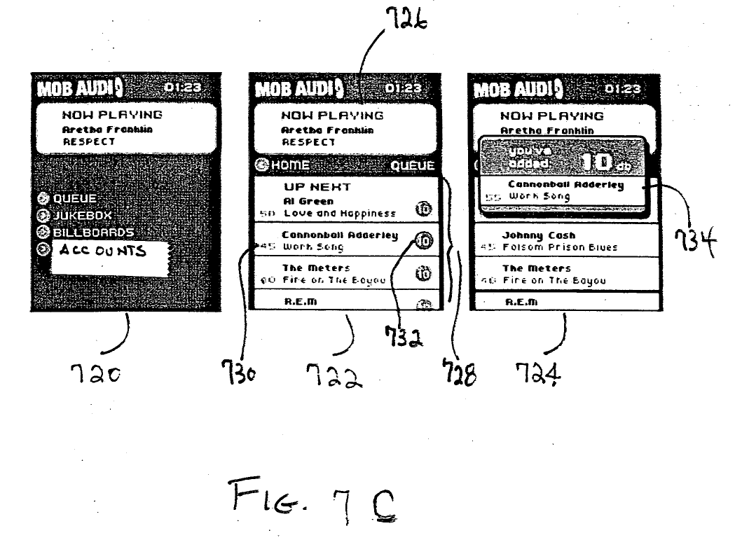

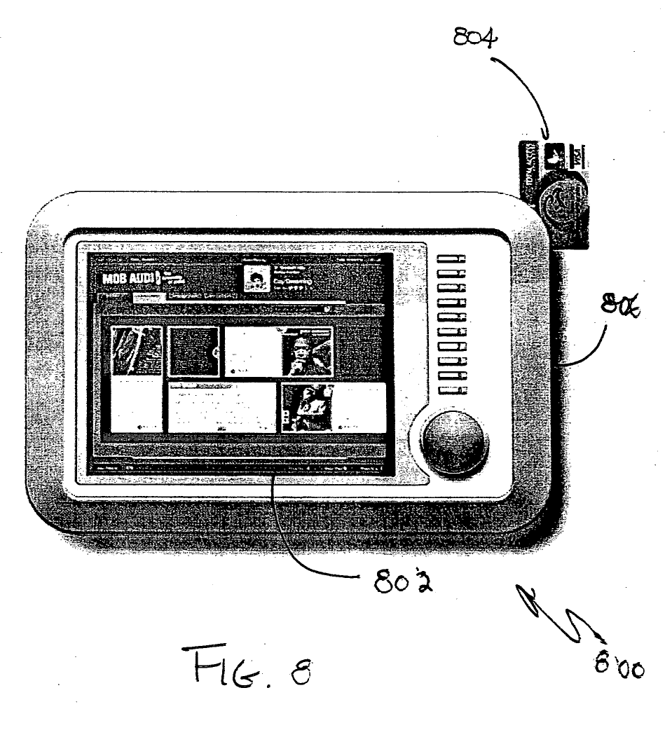

FIGS. 7A-7C illustrate an implementation of interface screens that may be displayed on a wireless handheld device such as a cellular phone or a personal digital assistant. FIG. 7A illustrates a series of displays 702-706 that may be displayed as a user logs onto the remote digital activation of digital media system. On screen 702 the user may be prompted for an identification 708 of the local digital media repository used in a venue. An error display 704 may display an error message 710 if an incorrect number is entered or unavailable from the location of the wireless device. Display 706 may be displayed to indicate that the wireless device is contacting the wireless network entered by the user.

FIG. 7B illustrates screens that may be displayed for a user to select an album track or entry into the public queue. An alphabetical listing 712 may be displayed to narrow the selection of choices. The listing may be by album title, artist, genre or another differentiating characteristic. The user may select a narrowing criterion. A listing of albums 714 from the local digital media repository meeting the user's criterion can be displayed on the user's wireless device. Upon selection by the user of one of the albums, a detailed screen 716 may be displayed with album information including the album title, artist, album art or album tracks. Associated with each album track may be a free text box 718. As described above, the user may enter a currency value to associate with a selected album track and enter the track into the public queue.

FIG. 7C illustrates a selection of screens that may be displayed to navigate through various levels of the media queue. For example, screen 720 enables the user to select one of the tabbed screens described above: queue, jukebox, billboards or accounts. Screen 722 shows a screen of the media queue. The name of the presently playing _selection can be displayed as well as the remaining entries 728 in the queue. The currency value 730 associated with a selection may be displayed. A button or free text entry box 732 may be provided to enable a user to add currency value to a selected album track in the queue. Display 724 shows a confirmation 734 that may be displayed after a user adds value to a selected entry.

FIG. 8 illustrates an implementation of a public use device 800 for remote activation of media in the public or private space. This type of device may be made available in the venue to enable users not having wireless devices to add selections to the public queue and compete to have their favored selections played sooner rather than later. The screens described above can be displayed in a display area 802 on the public device. The public use device can have a credit card swipe 806 to enable user's of the device to add currency value from their credit cards 804.

In an implementation, first-time users may receive an initial stored-value representing digital tokens or currency. Registered users maintain stored-value accounts on a central server. Additional funds may be added automatically to the account every time it drops below a predetermined value through a subscription service, a verified bank account or from a personal credit card. Users may also purchase anonymous account cards from venue owners. Registered users can access their accounts and their stored-value in any system-enabled environment.

In an implementation, a minimum value of currency may be required to promote an album track to a jukebox music queue. Users may browse the local content repository and select album tracks to add to the queue. The selection may be communicated to the system over a wireless network using, for example, http protocol. The jukebox contains all album tracks in media files such as MP3 files stored in a media repository. Once a selected album track has been promoted to the music queue, other system users can advance the selected track in the media queue by adding currency value in any amount. The queue updates itself and may be viewed by other users of the public queue. The album track with the highest value associated value of currency when the currently playing album track ends plays next.

Users may be encouraged to acquire “OnAir time” by getting selections that they submitted played in public. In an implementation, the length of the album track played measures “OnAir Time.” “OnAir Time” milestones may earn additional, free stored-value and a place in a local, regional and national rankings.

Various features of the system can be embodied in the form of computer-implemented processes and apparatuses for practicing those processes. Some or all of the features of the system can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The various features can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

Other implementations are within the scope of the following claims

1. A method of activating digital media on a network comprising:
allowing each user connected to the network to add digital media files to a media gaming queue accessible to each user of the network;
providing a visual indication of a sequence of the digital media files in the media gaming queue;
allowing each user to add currency units to one or more selected digital media files in the queue;
altering the sequence of the digital media files in the queue based on the respective currency units associated with each digital media file in the queue; and
activating a digital media player to play the digital media files in sequence from the queue.

2. The system of claim 1 wherein a media file with a first value of currency units associated with it is sequenced in the queue ahead of a media file having a lesser value of currency units associated with it.

3. A system to control the order of activating digital media files comprising:
a repository to store local content of digital media files;
a client/server to browse the local content coupled to the repository;
a local wireless network coupled to the client/server; and
a digital media player coupled to the repository to play activated digital media files in sequence from a media gaming queue wherein the sequence of the media files in the media gaming queue is determined by users of the system.

4. The system of claim 3 further comprising an account server coupled to the network to associate currency units with a user's stored-value account.

5. The system of claim 3 further comprising means to enable a user to associate currency units with one or more media files in the queue.

6. The system of claim 5 wherein the sequence of the media files in the gaming queue is determined by a respective value of currency units associated with each media file.

7. The system of claim 6 wherein a media file with a first value of currency units associated with it is sequenced in the queue ahead of a media file having a lesser value of currency units associated with it.

8. The system of claim 3 further comprising:
a retail server coupled to the network to enable the user to download media files to a user's computer;
a shopping cart server associated with the retail server to collect user requested downloads; and
an authorization system to enable payment from the user's stored-value account or from a credit card.

9. The method of claim 3 wherein the repository to receives content updates and user account verification over the network.

10. A method comprising:
receiving media files for entry into a media gaming queue;
allowing users to associate currency units with a respective media file;
sequencing the media files in the media gaming queue, the sequence being determined by a respective value of currency units associated with each media file; and
playing the media file on a media player in the sequence from the media gaming queue.

11. The system of claim 10 wherein a media file with a first value of currency units associated with it is sequenced in the queue ahead of a media file having a lesser value of currency units associated with it.

12. A method comprising:
coupling one or more users' device to a media player over a wireless network for playing media files in sequence from a media gaming queue in a space;
adding one or more media files from a local media repository to the media gaming queue; and
altering the sequence of the media files in the media gaming queue based on currency units associated with one or more selected media files.

13. The method of claim 12 wherein a value of currency units associated with one of the media files is altered in response to input by one or more.

14. The method of claim 13 wherein the currency units are representative of a stored-value associated with each respective user.

15. The method of claim 14 wherein the respective user can increase the stored-value associated with the respective user.

16. The method of claim 15 wherein the respective stored-value is increased by adding stored-value from a credit card account.

17. The method of claim 15 wherein the respective stored-value is increased in relation to the number of media files added to the media gaming queue by a respective user that are played on the media player.

18. A method comprising:
receiving media content updates for storage in a local media repository coupled to a wireless local area network from a central media server;
allowing one or more users connected to the wireless local area network to select one or more media files from the local media repository for addition to a media gaming queue; and
allowing one or more users to associate currency units with a respective media file in the media gaming queue.

19. The system of claim 18 comprising altering the sequence of the media files in the media gaming queue based on the currency units associated with the respective media file.

20. The system of claim 19 wherein a media file with a first value of currency units associated with it is sequenced in the queue ahead of a media file having a lesser value of currency units associated with it.

21. The method of claim 18 wherein the currency units are representative of a stored-value associated with each respective user.

22. The method of claim 21 wherein the user can increase the respective stored-value.

23. The method of claim 22 wherein the respective stored-value is increased by adding stored-value from a credit card account.

24. The method of claim 22 wherein the respective stored-value is increased in relation to the number of media files added to the media gaming queue by a respective user that are played on the media player.
